(19) United States
(12) Patent Application Publication
(10) Pub. No.: US 2004/0110005 A1
(43) Pub. Date: Jun. 10, 2004

(54) Carbon nano particles having novel structure and properties

(76) Inventors: Man Soo Choi, Seoul (KR); Young-Jeong Kim, Seoul (KR); Ji-Hyun Yi, Gwangmysong-si (KR); Igor Altman, Seoul (KR); Perto Pikhitsa, Seoul (KR)

Correspondence Address: David A. Einhorn, Esq., Anderson Kill & Olick, P.C., 1251 Avenue of the Americas, New York, NY, 10020, US

(21) Appl. No.: 10/376,823

(22) Filed: Feb. 28, 2003

(30) Foreign Application Priority Data
Feb. 28, 2002 (KR) 2002-11015

(51) Int. Cl. B32B 9/00

(52) U.S. Cl. 428/402

(57) ABSTRACT

The present invention relates to substantially spherical carbon nano particle having a novel structure, which comprises a plurality of layers formed by planar and curved graphene sheets which are connected to each other and a hollow inner core. The carbon nano particles of the present invention has field emission properties comparable to those of carbon nanotubes and can be advantageously used in such industries as aerospace, biotechnology, environmental energy, materials, medicine, electronics.

### FIELD OF THE INVENTION

The present invention relates to a carbon nano particle having a novel structure and properties.

### BACKGROUND OF THE INVENTION

Graphite and diamond had previously known to be an only crystalline forms of carbon. However, in 1985, Kroto of Sussex University of Great Britain and Smalley of Rice University of the United States discovered the existence of fullerene, called the third carbon allotrope, during an experiment of vaporizing graphite with laser, and then in 1990, Kratschmer of Germany and Huffman of Arizona University succeeded in a large scale production of fullerene by using arc discharge instead of laser, inspiring new researches of carbon materials. The discovery of carbon nanotube is considered to be the most important outcome of such studies.

A carbon nanotube is a tube-shaped material having an extremely small tube diameter in the order of nanometer(1×10⁻⁹ m) in which carbons are bonded with each another to form a hexagonal honeycomb structure (See FIG. 1). A carbon nanotube can be used as a novel quantum device, besides its use as a conventional electric device, since it has a quasi one-dimensional structure having properties of a conductor or a semi-conductor depending on the degree of structural distorsion, while graphite and diamond are a conductor and an insulator, respectively. Further, a carbon nanotube may act as a quantum wire through which electric current can theoretically be transmitted at an ultra high speed without resistance at a low temperature. A carbon natotube has an electric resistance lower than that of graphite at room temperature. Furthermore, a carbon nanotube is 100 times stronger than steel, very light and chemically stable. Also, a carbon nanotube exhibits increased diamagnetism as the temperature is lowered.

Carbon nanotubes may be prepared by electric discharge, pyrolysis, laser ablation, plasma chemical vapor deposition, thermal chemical vapor deposition, electrolysis, flame synthesis, etc. The application thereof has spread to such industries as aerospace, biotechnology, environmental energy, materials, medicine, electronics due to their good mechanical, electric, field emission properties as well as highly efficient hydrogen storage capability.

Carbon nano-onion is a material which has attracted as much attention as carbon nanotube. It is of a spherical shape made by onion skin-like carbon layers stacked on a core of fullerene such as C₆₀ (See FIG. 2). Researches on carbon nano-onion have been vigorously pursued by, for example, G. Amaratunga and M. Chhowalla of Cambrige University who have reported a method for preparing a carbon nano-onion of 25 to 30 nm diameter by arc discharge between two graphite electrodes immersed in water.

Typically, carbon nano particles have been prepared by subjecting a feed carbon material to a high power laser or arc, or by conducting chemical reactions such as burning or heating a gaseous or liquid hydrocarbon. However, these methods give a very low yield of carbon nanotubes. Accordingly, in order to overcome the problem of low yield, the present inventors have developed a method for preparing high purity shell-shaped carbon nano particles by irradiating with a laser early-stage carbon soot particles formed in a flame or pyrolysis process, which is disclosed in Korean Patent Application No. 2001-6618.

The present inventors have endeavored to study the structure and properties of carbon nano particles prepared by the method of Korean Patent Application No. 2001-6618, and found that carbon nano particles prepared by above method have unique structural and electric properties different from those of conventional carbon nanotubes or carbon nano-onion.

### SUMMARY OF THE INVENTION

It is, therefore, an object of the present invention to provide a carbon nano particle having a novel structure and electric properties different from those of the conventional carbon nanotube or carbon nano-onion.

### BRIEF DESCRIPTION OF THE DRAWINGS

The above and other objects and features of the present invention will become apparent from the following description thereof, when taken in conjunction with the accompanying drawings which respectively show:

FIG. 1: the structure of a conventional carbon nanotube;

FIG. 2: a transmission electron microscope (TEM) image of a carbon nano-onion (The size of the scale bar: 5 nm);

FIG. 3: a schematic sectional view of the carbon nano particle of the present invention;

FIG. 4: a TEM image of the carbon nano particle of the present invention (The size of the scale bar: 50 nm);

FIG. 5: a high magnification of TEM image of the carbon nano particle of the present invention (The size of the scale bar: 10 nm);

FIGS. 6a and 6b: electron paramagnetic resonance (EPR) data of noncrystalline carbon (soot) and the inventive carbon nano particle, respectively;

FIGS. 7a and 7b: X-ray diffractometer (XRD) results of noncrystalline carbon and the inventive carbon nano particle, respectively; and

FIGS. 8 and 9: field emission properties of the carbon nano particle of the present invention.

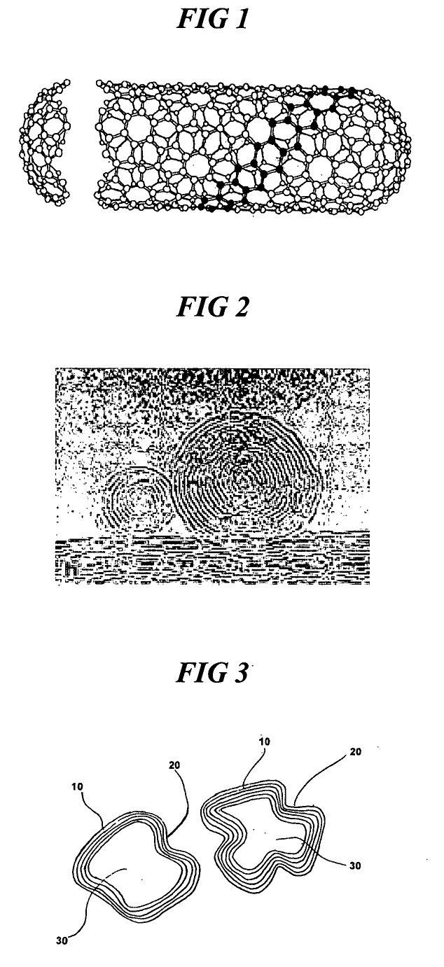

### DETAILED DESCRIPTION OF THE INVENTION

The present invention provides a carbon nano particle having a novel structure comprising a plurality of layers formed by planar and curved graphene sheets connected to each other and a hollow inner core.

In accordance with the present invention, the carbon nano particle is substantially spherical.

In accordance with the present invention, the average diameter of the inventive carbon nano particle is 100 nm or less.

The carbon nano particle of the present invention has field emission properties comparative to those of a carbon nanotube.

More specific embodiments of the present invention are described below.

The carbon nano particle of the present invention is similar to a carbon nanotube or carbon nano-onion in that they all have a shell structure, i.e., a layered structure, but, the carbon nano particle of the present invention is nearly spherical in shape unlike a carbon nanotube and has a hollow core unlike a carbon nano-onion.

The shell structure of the carbon nano particle of the present invention is shown schematically in FIG. 3. As can be seen from FIG. 3, the carbon nano particle of the present invention comprises individual layers comprising planar graphene (10) and curved graphene sheets (20) which are connected to each other and the inner core (30) of the particle is hollow. Therefore, it is clearly different from the conventional carbon nano particles having a shell structure.

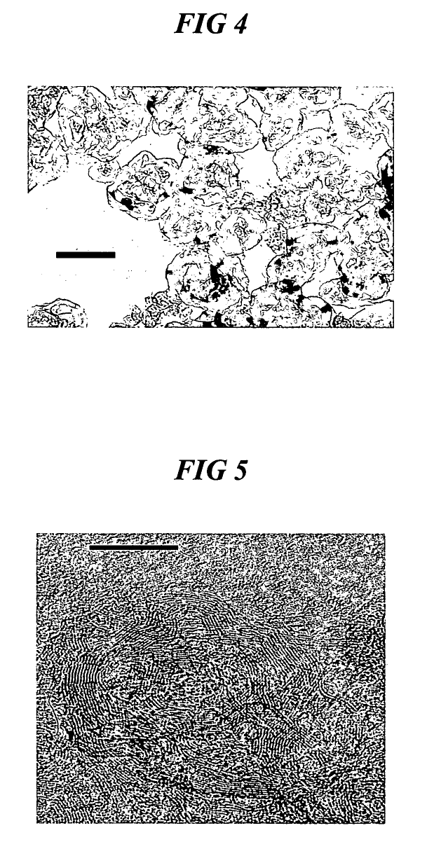

FIGS. 4 and 5 show TEM images of the carbon nano particle of the present invention. The size of the scale bar of FIG. 4 is 50 nm and that of FIG. 5 is 10 nm. From FIGS. 4 and 5, it can be recognized that the carbon nano particle of the present invention has a layered structure with a hollow core and each of the layers is made of planar and curved graphene sheets connected to each other.

As stated above, the present invention is accomplished by the unexpected finding that the carbon nano particle prepared in Korean Patent Application No. 2001-6618 entitled “A method for preparing shell-shaped carbon nano particle” has both a novel structure different from the conventional carbon nanotube or carbon nano-onion and novel electric properties. Accordingly, a general method for preparing the carbon nano particle of the present invention is referred to the above patent application No. 2001-6618.

A specific method for preparing the carbon nano particle in accordance with the present invention is as follows. Polycyclic aromatic hydrocarbons (PAHs) having chemically stable 5- and 6-membered rings are produced by pyrolysis of hydrocarbons, and PAHs thus produced are allowed to react with each other to form PAHs having larger molecular weights. Such a PAH growth process is inevitably accompanied by an increase in the carbon constitution ratio (the ratio of carbon and hydrogen) of PAH.

The boiling point of PAHs becomes higher as they grow and when the molecular weight thereof reaches 1000-2000 amu, PAH particles undergo condensation at relatively high temperature of about 1000K. Accordingly, if PAHs having sufficiently large molecular weight are produced by such rapid-growth pyrolysis procedure, they condense in flame or furnace to form PAH liquid-crystal droplets which are soot precursors.

The PAH liquid-crystal droplets thus produced still maintain high reactivity, and thus, they continuously react with external gaseous hydrocarbons while the internal reactions within the droplet take place. Such external and internal reactions result in an increase in the carbon content while the amount of hydrogen decreases, thus dramatically increasing the carbon constitution ratio. This procedure is called carbonization. In such a procedure, some parts of the surface or interior of the droplets are carbonizated, which is termed carbon nucleus production. Once carbon nucleus production occurs, PAH droplets are rapidly carbonized and converted into early-stage soot particles. When PAH droplets are allowed to convert completely into soot, physically and chemically stable mature-stage soot particles composed mostly of carbon and carbon nano particles are formed.

The carbon nano particles of the present invention may be prepared by irradiating with a laser the early-stage soot precursors having no carbon nucleus so that the soot precursors can be activated to react with an external gas, leading to accelerated carbonization of the particle surface.

Since soot precursors contain a significant amount of hydrogen having high chemical reactivity, their chemical reactivity is higher than that of mature soot particles which are practically comprised of carbon. If the irradiating laser power reach a predetermined level, a carbon layer having a shell structure is formed on the precursor surface by the occurrence of rapid carbonization of the surface before any chemical change in the inner part of the precursor particle such as nucleus production occurs. The inner part of the precursor particle is heated then vaporized, the vapor migrates to the surface, and anoher layer of carbon is formed on the surface. Such reaction cycle is repeated to form the shell-shaped carbon nano particles of the present invention. If the soot precursors are irradiated with a laser focused using a spherical condenser lens, shell-shaped carbon nano particles of 100 nm or less are produced.

The above procedure only illustrates one example of the present invention, which are not intended to limit the scope of the present invention. That is, in the future alternative preparation procedures may be developed when the demand for the carbon nano particles of the present invention having novel properties is enlarged.

The inventors have confirmed that the carbon nano particle of the present invention has a unique stucture formed by planar and curved graphene sheets, and has unique electric properties as described below.

Structural Features

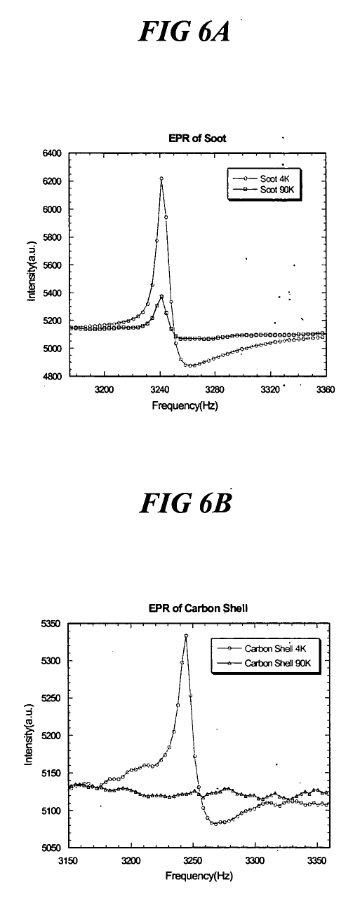

FIGS. 6a and 6b are EPR (Electron Paramagnetic Resonance) data of noncrystalline carbon (soot) and the carbon nano particles of the present invention, respectively. Both FIGS. 6a and 6b show the existences of a peak at 4K, while only FIG. 6a (noncrystalline carbon) exhibits a peak at 90K. Since the electron magnetogyric ratio is about 1000 times larger than that of atom nucleus, the electron-spin resonance frequency, GHz, is about 1000 times higher than the nuclear magnetic resonance frequency, MHz, at a comparable intensity (ca. 1T) of magnetic field. Furthermore, in case of electrons of an atom, energy levels thereof are each determined by the total angular momentum derived from the combination of orbital angular momentum and spin angular momentum, and resonance may occur between the levels split by a magnetic field. Accordingly, resonance may occur when the total angular momentum of electron is not zero (0). This resonance is called electron paramagnetic resonance (EPR) which is to be distinguished from electron-spin resonance, and both of them are included in the term, electron magnetic resonance (EMR). Electron magnetic resonance is applied to detect the magnetogyric ratio of electrons and to distinguish the atom type. For noncrystalline carbon particles, the ratio of sp2 and sp3 bonds becomes an important parameter for distinction, sp2 bond serving as a parameter to define the electron spin resonance (ESR) characteristics. Accordingly, conventional noncrystalline carbon particles and shell-shaped carbon nano particles can be differentiated by EPR analysis. EPR analysis was conducted at 4K and 90K to compare the properties of noncrystalline forms of carbon and shell-shaped carbon nano particles. Both showed the same electron spin resonance characteristics at 4K, while only the noncrystalline carbon exhibited a weak peak at 90K at around 3240 Hz, the shell-shaped carbon nano particle showing no peak.

Accordingly, the carbon nano particles of the present invention contain no noncrystalline carbon atoms.

Furthermore, it was confirmed from a TEM photograph that the carbon nano particle of the present invention has outer shells consisting of graphene sheets and that the carbon nano particle of the present invention is hollow.

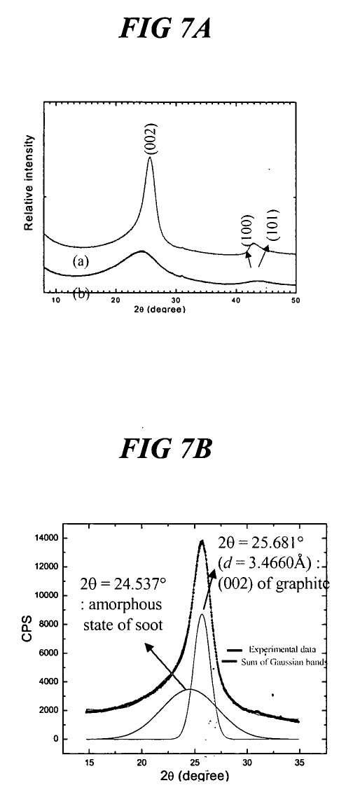

FIGS. 7a and 7b show XRD (X-ray Diffractometer) analysis results of noncrystalline carbon and inventive carbon nano particle, respectively. FIG. 7b clearly shows (100), (101) and (002) peaks and the nonsymmetrical shape of (002) peak is considered to be caused by the coexistence of planar and curved graphene sheets. FIG. 7b also shows two deconvoluted peaks based on FIG. 7a; a broad peak at 24.537° and a narrow peak at 25.681°. The narrow peak at 25.6810° exactly matches with graphite, while the broad peak at 24.537° generally represents a distorted phase. Thus, these peaks are believed to show the existence of planal and curved graphene sheets in the carbon nano particles of the present invention.

Electric Features

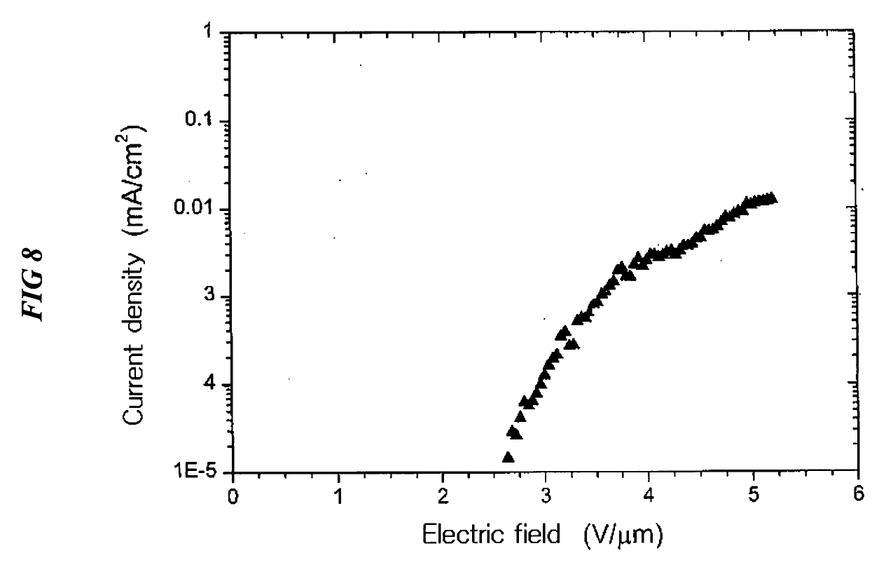

The carbon nano particles of the present invention was found to have superior field emission properties. FIG. 8 for the carbon nano particles of the present invention shows an field emission-causing electric field of 3 to 4 V/μm, which is similar to the field emission property of carbon nanotubes.

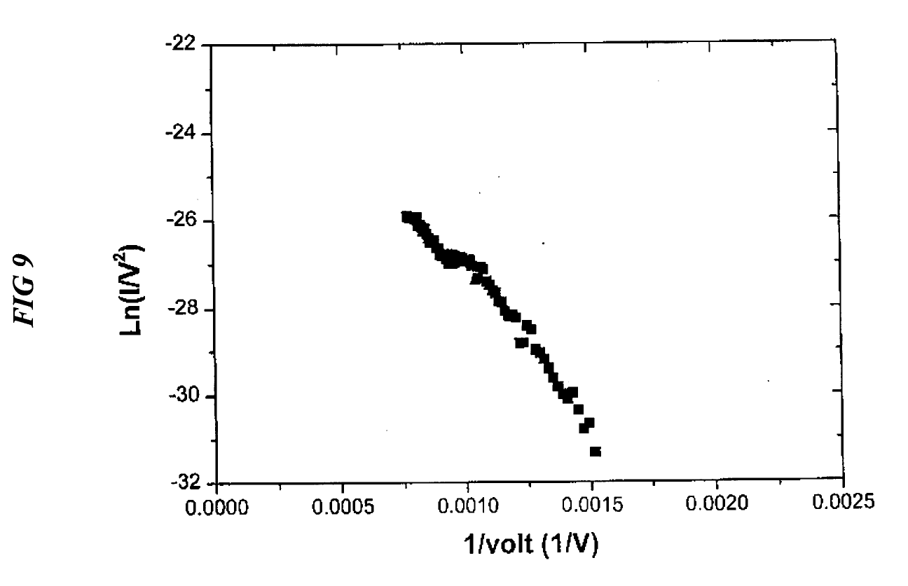

Also, FIG. 9 shows a Fowler-Nordheim Curve, which can be meaningfully used when the local electric field is less than 5V/μm, the emission properties at which the current density becomes more than 1E-3 mA/cm². Thus, FIG. 9 suggests that the carbon nano particles of the present invention have field emission properties in the range of about 3 to 4 V/μm.

While the invention has been described with respect to the above specific embodiments, it should be recognized that various modifications and changes may be made to the invention by those skilled in the art which also fall within the scope of the invention as defined by the appended claims.

What is claimed is:

1. A carbon nano particle comprising a plurality of layers of planar and curved graphene sheets which are connected to each other and a hollow inner core.

2. The carbon nano particle of claim 1, which is substantially spherical.

3. The carbon nano particle of claim 1 or 2, which has an average particle diameter of 100 nm or less.

4. The carbon nano particle of claim 1 or 2, which has an electric field emission property of 3 to 4 V/μm.

5. The carbon nano particle of claim 1 or 2, which exhibits (002), (100) and
(101) X-ray diffractometer peaks, the (002) peak having a nonsymmetrical shape.
